(19) United States
(12) Patent Application Publication
(10) Pub. No.: US 2006/0085203 A1
(43) Pub. Date: Apr. 20, 2006

(54) COMPUTER-IMPLEMENTED METHOD AND SYSTEM FOR DETERMINING VEHICLE DELIVERY ESTIMATED TIME OF ARRIVAL

(75) Inventors: Brian Schweickart, Grosse Ile, MI (US); Mary Jo Koenigbauer, Ira Township, MI (US); William Fravel, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 10/904,006

(22) Filed: Oct. 19, 2004

(51) Int. Cl. G06Q 99/00

(52) U.S. Cl. 705/1

(57) ABSTRACT

An integrated computer-implemented method for determining a delivery estimated time of arrival (“ETA”) for a vehicle. The method includes receiving post-release quality hold information, upfitter throughput information and historical delivery segment performance information relating to an undelivered vehicle; and determining a delivery ETA for the undelivered vehicle based on the post-release quality hold information, upfitter throughput information and historical delivery segment performance information. The delivery ETA is relied upon by the vehicle customer as an estimate of actual time of arrival.

### BACKGROUND OF THE INVENTION

1. Field of the Invention

One aspect of the present invention generally relates to a vehicle logistics method and system, and more specifically, a computer-implemented method and system for determining vehicle delivery estimated time of arrival (“ETA”).

2. Background Art

Vehicle delivery estimated time of arrival (“ETA”) information is relied upon by various customers, internal and external to vehicle manufacturers. Non-limiting examples of customers include fleet customers, individual customers and vehicle dealers.

In the case of individual customers, they typically visit a dealer location to shop for a motor vehicle. Many times, the customer purchases a vehicle which is not available at the dealer location at the time of purchase, thus necessitating production and delivery of the vehicle to the dealer location at a later date. This situation commonly arises when a customer wants a customized vehicle. In these instances, the dealer commonly provides the customer with a delivery estimated time of arrival (“ETA”) for the vehicle upon purchase.

In the case of dealers, they typically conduct market studies of vehicles to identify those vehicles that will sell at their dealer location. Often, the vehicles identified by the study are not available at the dealer location. In these instances, the dealer will contact the manufacturer to inquire as to whether the manufacture can provide such vehicles. If the manufacturer has the capacity, the dealer's next question is when will the vehicles arrive at the dealership, i.e. a delivery ETA.

In the case of fleet customers, fleet managers identify a group of vehicles necessary to carry out the objectives of the fleet. Similar to the dealers' approach, the fleet manager checks with the manufacturer for capacity to fulfill an order for the group of vehicles, and a delivery ETA.

In all cases, the delivery ETA is commonly computed based on the vehicle manufacturer's inventory, the extent of customization, number of vehicles requested, etc. Delivery ETA is difficult to estimate since many parties may be involved with the vehicle delivery logistics plan. For example, the logistics plan may include upfitters, carriers, manufacturers, ramp operators, and dealers. Due to the complexity of the logistics concerning vehicle delivery, many current methods for calculating vehicle delivery ETAs for customers have been historically inaccurate and unreliable, leading to customer dissatisfaction.

In light of the foregoing, what is needed is a computer-implemented method and system for determining delivery ETA that relatively increases customer satisfaction and the reliance that the customer places on the delivery ETA information. What is also need is a method for determining a reliability factor associated with the delivery ETA information.

### SUMMARY OF THE INVENTION

One aspect of the present invention is a computer-implemented method for estimating vehicle delivery ETA. Another aspect of the present invention is a method for determining a reliability factor associated with the delivery ETA information.

According to one embodiment of the present invention, an integrated computer-implemented method for determining a delivery estimated time of arrival (“ETA”) for a vehicle is disclosed. The method includes receiving post-release quality hold information, upfitter throughput information and historical delivery segment performance information relating to an undelivered vehicle, and determining a delivery ETA for the undelivered vehicle based on the post-release quality hold information, upfitter throughput information and historical delivery segment performance information. The delivery ETA is relied upon by the vehicle customer as an estimate of actual time of arrival. In certain embodiments, the method further includes determining a reliability factor associated with the delivery ETA based on historical delivery segment performance information.

In certain embodiments, the method further includes receiving one or more notifications of an actual event. The step of determining the reliability factor can be triggered upon receiving the one or more notifications of an actual event. The upfitter throughput information can include one or more upfitter milestone event throughput times. The upfitter throughput information can include the historical throughput information. The upfitter throughput information can be transmitted by one or more upfitters. The above method can further include receiving historical ramp throughput performance information. The historical ramp throughput performance information can be transmitted by one or more ramp operators or surrogates.

The above method can further include determining a delivery ETA based on the historical ramp throughput performance information, the post-release quality hold information, upfitter throughput information and historical delivery segment performance information. The method can also further include receiving one or more exception codes for delays in the delivery process. The method can also further include determining a delivery ETA based on one or more exception codes, post-release quality hold information, upfitter throughput information and historical delivery segment performance information. The method can further include receiving one or more forecasted event timings.

The above method can further include determining a delivery ETA based on one or more forecasted event timings, the post-release quality hold information, upfitter throughput information and historical delivery segment performance information. The method can further include receiving plan segment operating information.

The method can further include determining a delivery ETA based on the plan segment operating information, post-release quality hold information, upfitter throughput information and historical delivery segment performance information. The method can further include receiving one or more manufacturer parameter controls. The method can further include determining a delivery ETA based on one or more manufacture parameter controls, post-release quality hold information, upfitter throughput information and historical delivery segment performance information.

According to another embodiment of the present invention, an integrated computer implemented system for determining a delivery estimated time of arrival for a vehicle is disclosed. The system includes one or more server computers and one or more client computers. The one or more client computers is configured to receive post-release quality hold information, upfitter throughput information and historical delivery segment performance information relating to an undelivered vehicle and the determined delivery ETA for a delivery ETA for the undelivered vehicle based on the post-release quality hold information, upfitter throughput information and historical delivery segment performance information. The delivery ETA is relied upon by the vehicle customer as an estimate of actual time of arrival.

According to another embodiment of the present invention, an integrated computer implemented apparatus for determining a delivery estimated time of arrival for a vehicle is disclosed. The apparatus includes a means for receiving post-release quality hold information, upfitter throughput information and historical delivery segment performance information relating to an undelivered vehicle and a means for determining a delivery ETA for the undelivered vehicle based on the post-release quality hold information, upfitter throughput information and historical delivery segment performance information. The delivery ETA is relied upon by the vehicle customer as an estimate of actual time of arrival.

The above and other objects, features, and advantages of the present invention are readily apparent from the following detailed description of the best mode for carrying out the invention when taken in connection with the accompanying drawings.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings which:

FIG. 1 is a context diagram for the delivery ETA determination made in accordance with an embodiment of the present invention;

FIG. 2 is a data source and component diagram for determining delivery ETA in accordance with one embodiment of the present invention; and

FIG. 3 is a block diagram of the system architecture of a system according to one embodiment of the present invention.

### DETAILED DESCRIPTION OF EMBODIMENTS OF THE PRESENT INVENTION

As required, detailed embodiments of the present invention are disclosed herein. However, it is to be understood that the disclosed embodiments are merely exemplary of the invention that may be embodied in various and alternative forms. Therefore, specific functional details herein are not to be interpreted as limiting, but merely as a representative basis for the claims and/or as a representative basis for teaching one of ordinary skill in the art to variously employ the present invention.

It is understood that customers can refer to fleet customers, individual customers or vehicle dealers.

Reference is now made to several terms used through the application. While the terms are understood by ones of ordinary skill in the art, the following definitions are meant to supplement that understanding.

It is understood that delivery ETA can refer to estimated time of arrival at the final destination from release of vehicle to carrier.

It is understood that historical segment throughput can refer to the amount of time, usually in days and hours, required to execute an aspect of the vehicle logistics delivery process based on representative, otherwise referred to as non-exception, history defined by manufacturer parameters and factored by the operating schedule associated with each historical record.

It is understood that planned segment operating schedule can refer to the amount of time, usually in days and hours, of planned operation as a percentage of normal operating capacity. For example, no operations on Sunday means that the throughput capability is zero.

It is understood that ramp refers to a facility or service provider which unloads vehicles from conveyances and/or consolidates and loads vehicle to common destinations for furtherance to their ultimate destination.

It is understood that segment can refer to the smallest increment of post-release activity the manufacturer chooses to measure. Segments are defined by milestone events such as “post-release plant dwell time” being bounded by the “vehicle released to carrier” and “vehicle loaded” milestones. Segments also include activities occurring at the upfitter.

It is understood that segment ETA is the result of the determination which identifies when a specific segment is expected to be completed. This value is ultimately determined through the point of delivery to the final destination.

It is understood that trigger can refer to the reporting of an executed or planned milestone event. A trigger initiates redetermination of the delivery ETA and reliability factor. There are typically many milestones in the delivery process which, when reported, become the starting point from which the remaining segments are determined.

It is understood that upfitter can refer to a third party usually contracted by a manufacturer to provide certain vehicle modifications for fleet orders. Upfitters typically receive vehicles after they have been gate released by the assembly plant, perform one or more modifications, and send the vehicle back into the logistics network for subsequent delivery. There are many milestones within the upfitter process. Non-limiting examples include vehicle arrives at upfitter, vehicle scheduled for upfit, vehicle upfit complete, vehicle released to carrier, etc. Upfitter processes are referred to herein as segments within the delivery network.

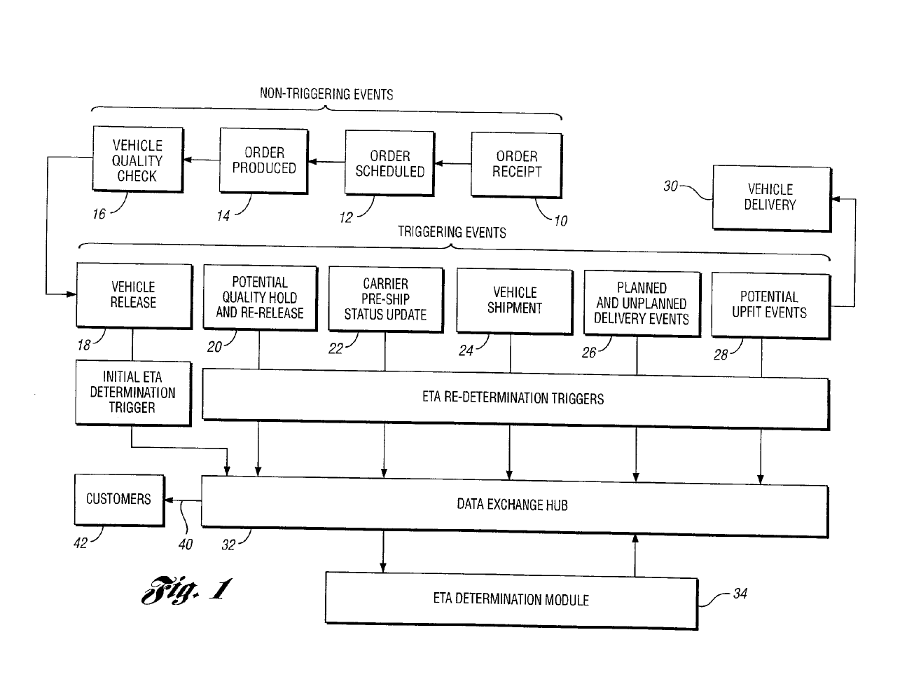

FIG. 1 is a context diagram for the delivery ETA determination made in accordance with an embodiment of the present invention. It is understood that the sequence and arrangement of events depicted on FIG. 1 is but one implementation of a vehicle delivery logistics process, and revisions, additions, and deletions to the plan can be made in accordance with the present invention. Globally, the vehicle delivery logistics process is broken down into two event categories, non-trigger events and trigger events. Non-trigger events do not trigger the ETA determination, and include, but are not limited to, order receipt 10 by manufacturer, order scheduled 12 by manufacturer, order produced 14 by manufacturer, and vehicle quality check 16.

Trigger events are broken up into two categories, initial ETA determination and ETA redetermination. The initial ETA determination trigger event can be the vehicle being released to the carrier, as depicted by block 18. The source of information generated by this event is the manufacturer.

There are several ETA redetermination trigger events. For example, potential quality hold and re-release is a redetermination event, as depicted in block 20. The source of information generated by this event can be the manufacturer. Another redetermination event is an update to a carrier pre-ship status, as depicted in block 22. Examples of status updates, include, but are not limited to, load planning and dispatch. The source of information generated by this event can be the carrier. Another redetermination event is vehicle shipment, as depicted by block 24. The source of information generated by this event can be the carrier.

Another redetermination event is planned and unplanned delivery events, as depicted by block 26. Non-limiting examples of these events include ramp arrivals, dwells, departures, force majeure, and diversions. The sources of information generated by these events can be the carrier and manufacturer.

Another redetermination event is potential upfit events, as depicted by block 28. Non-limiting examples of these events include arrival, upfit schedule, and departure. The source of information generated by these events is the upfitters.

After the upfit events occur, as well as the other trigger events, the vehicle is delivered to the dealer location or other destination, as depicted in block 30.

Any time a triggering event occurs, data is transmitted via communication lines to data exchange hub 32, which in turn is in communication (represented by broken arrows of claim 1) with ETA determination module 34. ETA trigger data is transmitted to module 34, as depicted by arrow 36. The module determines the deliver ETA and communicates the information to data exchange hub 32, as depicted by arrow 38. As depicted by arrow 40 and block 42, the delivery ETA information is communicated to one or more customer, either electronically or otherwise. Non-limiting examples of customers include fleet customers, individual customers and vehicle dealers.

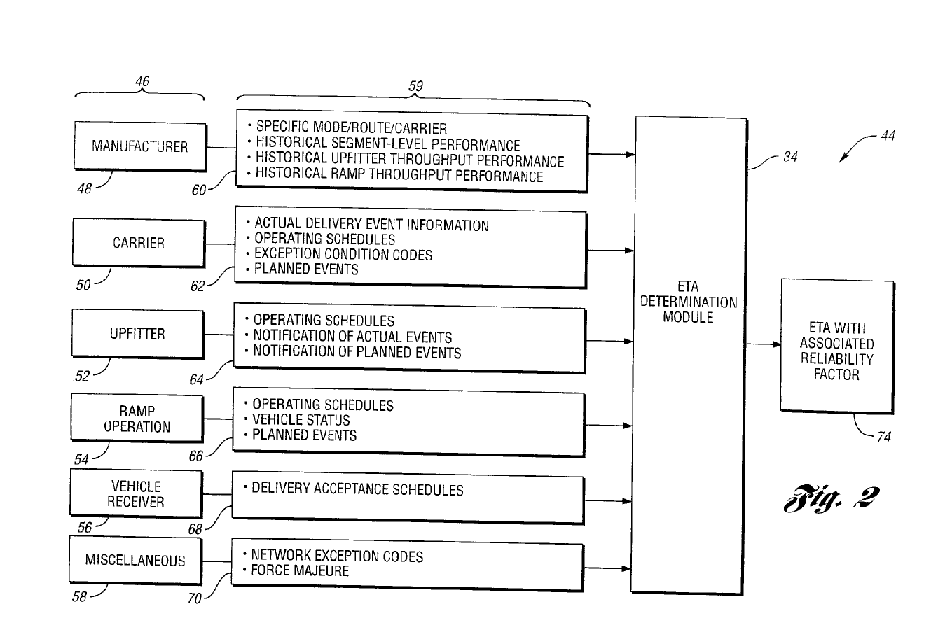

FIG. 2 is a data source and component diagram for determining delivery ETA in accordance with one embodiment of the present invention. Having described in detail the context of the ETA determination and redetermination, FIG. 2 identifies the multiple data sources and components used in the determination. It should be understood that not all data components are necessary to determine a delivery ETA, and the determination depends on the nature of the vehicle delivery logistics plan. Flowchart 44 includes column 46 of data sources for the ETA determination. Data sources, include, but are not limited to, manufacturer 48, carrier 50, upfitter 52, ramp operator 54, vehicle receivers 56, and miscellaneous 58. Non-limiting examples of vehicle receivers include dealers, fleet customers, and individual customers.

Flowchart 44 includes column 59 of data components used in the ETA determination. The data components are described in greater detail below. As depicted in block 60, manufacturer 48 can provide the following data components: specific mode/route/carrier, historical segment-level transit performance, historical upfitter throughput performance, and historical ramp throughput performance. As depicted in block 62, carrier 50 can provide the following data components: actual delivery event information including dates and times, operating schedules (e.g. holidays), unique coding identifying exception conditions, and planned events (e.g. load make-up) with projected ship date and time. As depicted in block 64, upfitter 52 can provide the following data components: operating schedule, notification of actual events impacting ETA (e.g. vehicle arrival, upfit completion, and departure), and notification of planned events impacting ETA (e.g. scheduled upfit completion date). As depicted in block 66, ramp operator 54 can provide the following data components: operating schedules, vehicle status (e.g. arrived, unloaded dispatched, etc.), and planned events (e.g. scheduled unload, reload, departure, etc.). As depicted in block 68, vehicle receiver 56 can provide delivery acceptance schedules. As depicted by block 70, miscellaneous sources 58 can provide the following data components: network exception conditions (e.g. road repairs) and force majeure.

As depicted by block 34, at least some of the data components described above are passed to ETA determination module. In certain embodiments, ETA determination module can also include a reliability module for determining a reliability factor associated with the determined ETA. The delivery ETA with associated reliability factor can be provided to manufacturers, dealers, fleet customers, individual customers, carriers, and ramp operators, as depicted in block 74.

One aspect of the present invention relates to an integrated computer-implemented method for determining a delivery estimated time of arrival (“ETA”) for a vehicle. The integrated method can be implemented using a computer system. According to one embodiment of the present invention, the system includes a central server in communication with a database and a number of computer systems. Non-limiting examples of computer systems include upfitter computer systems, carrier computer systems, manufacturer computer systems, dealer computer systems, and ramp operator computer systems.

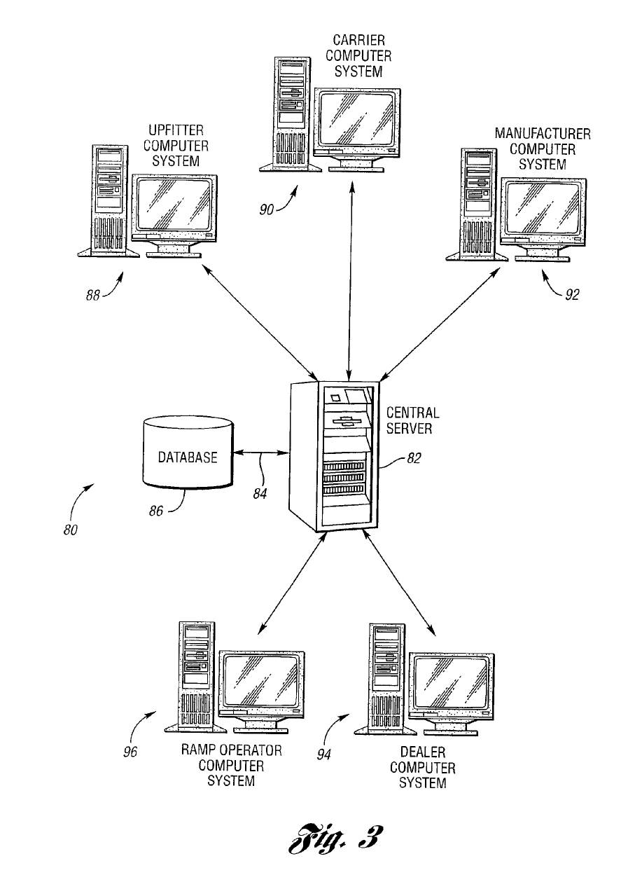

FIG. 3 is a block diagram illustrating overall system 80 for implementing one embodiment of the present invention. Overall system 80 includes central server 82, which is connected through communication line 84 to database 86. In certain embodiments, central server 82 contains ETA determination module 34, which is depicted in FIGS. 1 and 2. Central server 82 can also serve as data exchange hub 32 depicted in FIG. 2. Central server 82 is also connected via communication lines to upfitter computer system 88, carrier computer system 90, manufacturer computer system 92, dealer computer system 94, and ramp operator computer system 96. It is understood that systems 88 through 96 can transmit data to database 86 through central server 12 and communication line 84. Central server 82, database 86, and systems 88 and 96 can be interconnected to a network, for example a local area network (LAN) or a wide area network (WAN), through a variety of interfaces, including, but not limited to dial-in connections, cable modems, high-speed lines, and hybrids thereof.

Computer systems 88 through 96 typically each include one or more server computers for serving users of the system, one or more client computers for interfacing with users of the system, and one or more databases for storage of information used by the system. Non-limiting examples of servers that can be utilized within systems 88 through 96 include database servers, application servers, web servers, directory servers, and mail servers. It will be apparent that the components of systems 88 through 96 depend on the nature of the system.

According to the embodiment depicted in FIG. 3, computer systems 88 through 96 and central server 82 support TCP/IP protocol which has input and access capabilities via two-way communication lines. Another non-limiting example of supportable protocol is voice over Internet protocol, otherwise referred to as VoIP. Central server 82 includes a storage module for storing information to database 86 and a retrieval module for retrieving data stored in database 92.

The communication lines included in computer system 80 can be an intranet-adaptable communication line, for example, a dedicated line, a satellite link, an Ethernet link, a public telephone network, a private telephone network, and hybrids thereof. The communication lines can also be Intranet-adaptable. Examples of suitable communication lines include, but are not limited to, public telephone networks, public cable networks, and hybrids thereof. It is understood that firewalls can be provided between any computer system 88 through 96 and central server 82.

According to one embodiment of the present invention, an ETA determination process is disclosed which includes receiving post-release quality hold information, upfitter throughput information and historical delivery segment information relating to a customer's undelivered vehicle and determining a delivery ETA for the customer's undelivered vehicle based on the post-release quality hold information, upfitter throughput information and historical delivery segment performance information. The delivery ETA is relied upon by the customer as an estimate of actual time of arrival. Although certain information is used in the ETA determination above, it is understood that this information can be supplemented or deleted in accordance with the present invention.

In general terms, the delivery ETA determined using the above-identified process is the sum of delivery events, transit time for each downstream component or segment, and special conditions. The last two terms account for time from origin to final delivery destination; planned mode, route, and vehicle order type; compilations of information from all components or segments using history (considering time of day, day of week, exclusion of user definable exception conditions, pipeline volume, seasonality, and user control of minimum representative volumes); and adjustments for fleet customers requested delivery date. In addition, a reliability factor can be computed in the framework of the above-identified process. In certain embodiments, the reliability factor is computed as a statistical probability of hitting projected delivery ETA based on historical performance. In certain embodiments, it can be computed to the day as well as plus or minus one business day.

The above-identified process uses a segmented approach to determining delivery ETA. The process can determine a delivery ETA (final delivery destination) for each vehicle entering the delivery network. The determination is typically triggered by either the reporting of milestone events that have occurred or by forecasted milestone events. In certain embodiments, the process progressively determines a segment at a time in which the result of each segment (segment ETA) drives the determination of the next consecutive segment. In certain embodiments, the process determines only the remaining (not yet executed) segments from the trigger point to the final destination. The segment ETA is initial actual or planned segment milestones or prior segment ETA results plus historical throughput time, adjusted for planned segment operating schedule. The delivery ETA is the result of the determination of the segment ETA for the final planned segment.

According to one embodiment of the present invention, a method is disclosed for determining a reliability factor associated with the delivery ETA. One reason for determining the reliability factor is for customer satisfaction purposes since it is beneficial for recipients of a delivery ETA to know how reliable the ETA determination has been historically. The reliability factor represents the standards mathematical probability based on the representative historical records selected for inclusion in the delivery ETA determination.

In certain embodiments, upfitter throughput information is a data component for the ETA determination. Upfitter throughput information is commonly used with fleet vehicles that are specially modified, i.e. “upfit”, to meet a customer's requirements. Therefore, the time for upfit is factored into the ETA determination.

One example of such information is historical upfitter throughput performance (“upfitter throughput”), which is defined as the amount of time it takes a vehicle to go through various stages of upfit. Upfitter throughput is typically determined based on historical event records normally kept by upfitters. In certain embodiments, the delivery ETA determination can compensate for upfitter throughput if a vehicle requires upfit. In such instances, the ETA process determines whether a vehicle requiring upfit is pending all or a portion of an upfit process. The typical time, excluding statistical anomalies, of each uncompleted upfit event is accumulated and added to the ETA determination. In certain embodiments, the historical throughput time is utilized in the context of their associated operating plan conditions. For example, upfit throughput average is computed considering factors such as the number of shifts the upfitter operated over the weekend.

Another example of upfitter information is historical ramp throughput performance (“ramp throughput”). Most vehicles are typically routed through at least one delivery ramp. Ramp throughput is typically determined based on historical event records kept by ramp operators or their surrogates. In certain embodiments, the ETA determination can compensate for ramp throughput if a vehicle is routed through one or more ramps. The typical time, excluding statistical anomalies, of each uncompleted ramp throughput event is accumulated and added to the ETA determination. In certain embodiments, the historical throughput times are utilized in the context of their associated operating plan conditions. For example, ramp throughput average is computed considering factors such as the number of loading shifts operated over the weekend.

In certain embodiments, unique exception coding information is a data component for the ETA determination. Unique exception coding refers to standardized designations of various types of delays that can occur during the delivery process. Understanding that some delay types are recurrent, exception coding provides a means to utilize data to determine the expected delay on delivery timing. Standard delay codes can be assigned based on exception conditions originating with carriers (e.g. work stoppage), dealers (e.g. request to have units held at ramp), internal problems (e.g. quality hold or return to plant). These codes can be distributed to the appropriate ramp operator or carrier. The carrier then submits the code within a delivery transaction set, thereby providing visibility to the delay condition. Submission of exception codes in a carrier event or delivery records signals the ETA determination to search through the delivery history for a pervious delay of the same type. The ETA process then determines the typical delay period associated with that type of exception, and adds the additional transit to the delivery ETA.

In certain embodiments, forecasted event timings of milestone events (“triggers”) are data components for the ETA determination. These dates and/or times indicate expected timing of key operation events such as when a conveyance full of vehicles is expected to be loaded, dispatched, and ultimately departed from the loading location. The values for the triggers can originate from any participant in the delivery process including the manufacturer, carriers, upfitters, ramp operators, and dealers/customers. In certain embodiments, the triggers are used in the ETA determination as firm points from which to determine the remainder of the delivery time.

In certain embodiments, notification of the date and time of actual events (“notification triggers”) are data components for the ETA determination. These events include, but are not limited to, vehicles received, loaded onto delivery conveyance, dispatched, delivered, etc. As delivery events occur, these triggers become a firm “stake in the ground” for calculating the remaining delivery time. This information then becomes the basis for computing a historical number subsequently used for calculating future ETAs. Events are communicated via transactions between a manufacturer and upfitters or carrier service providers. Additionally, some transactions are generated by the manufacturer, such as the “released to carrier” event. In certain embodiments, actual event dates and times can be (1) used directly by the ETA process as a trigger for redetermining an ETA, (2) used to establish the baseline from which the ETA process will compute the balance of the delivery time, and (3) retained in history and subsequently used to calculate a statistically significant representation of the time required to execute that component or delivery, and is therefore used by ETA process on future vehicle delivery ETA determination.

In certain embodiments, planned segment operating plan can be used as data component in the ETA process. The planned segment operating plan indicates the planned dates and times services will be provided and to what level of capacity. Operating plans are used in the ETA process because they define the window of actual activity. Operating plans are relevant from all participants if the vehicle delivery process. An example of such plans would be a ramp operator advising the hours of weekend operations and the associated manpower level during a holiday period. The ETA process uses this input to adjust the ETA for the fact that the delivery network is limited to less than a 24/7 schedule. The ETA process adjusts the ETA to be either sooner or later than the standard delivery time based on operating schedules of all the participants in the logistics path.

In certain embodiments, manufacturer parameter controls can be used as data components for the ETA process. The manufacturer parameter controls are user-defined variable factors used by central server 12 and its modules to determine representative historical delivery records. These controls include minimum historical volume control and time frame from which to select historical delivery transactions. Parameter controls are used in the ETA process because they define the window of actual activity. Minimum historical volume parameters provide that a statistically significant volume of delivery transactions are available in history to extrapolate representative throughput days and times. For example, the ETA process compensates for a history of only one unit ever being shipped across a specific route. Time frame parameters which regulate the period of historical delivery transactions to be used by the calculator for computing a historical segment performance.

While the best mode for carrying out the invention has been described in detail, those familiar with the art to which this invention relates will recognize various alternative designs and embodiments for practicing the invention as defined by the following claims.

What is claimed is:

1. An integrated computer-implemented method for determining a delivery estimated time of arrival (“ETA”) for a vehicle, the method comprised of:
receiving post-release quality hold information, upfitter throughput information and historical delivery segment performance information relating to an undelivered vehicle; and
determining a delivery ETA for the undelivered vehicle based on the post-release quality hold information, upfitter throughput information and historical delivery segment performance information.

2. The method of claim 1 further comprising determining a reliability factor associated with the delivery ETA based on historical delivery segment performance information.

3. The method of claim 2 further comprising receiving one or more notifications of an actual event.

4. The method of claim 3 wherein the determining step of claim 2 is triggered upon receiving the one or more notifications of an actual event.

5. The method of claim 1 wherein the upfitter throughput information is comprised of one or more upfitter milestone event throughput times.

6. The method of claim 5 wherein the upfitter throughput information includes historical throughput information.

7. The method of claim 6 wherein the historical throughput information is transmitted by one or more upfitters.

8. The method of claim 1 further comprising receiving historical ramp throughput performance information.

9. The method of claim 8 wherein the historical ramp throughput performance information is transmitted by one or more ramp operators or surrogates.

10. The method of claim 8 further comprising determining a delivery ETA based on the historical ramp throughput performance information, the post-release quality hold information, upfitter throughput information and historical delivery segment performance information.

11. The method of claim 1 further comprising receiving one or more exception codes for delays in the delivery process.

12. The method of claim 11 further comprising determining a delivery ETA based on one or more exception codes, the post-release quality hold information, upfitter throughput information and historical delivery segment performance information.

13. The method of claim 1 further comprising receiving one or more forecasted event timings.

14. The method of claim 13 further comprising determining a delivery ETA based on one or more forecasted event timings, the post-release quality hold information, upfitter throughput information and historical delivery segment performance information.

15. The method of claim 1 further comprising receiving planned segment operating information.

16. The method of claim 15 further comprising determining a delivery ETA based on the planned segment operating information, the post-release quality hold information, upfitter throughput information and historical delivery segment performance information.

17. The method of claim 1 further comprising receiving one or more manufacturer parameter controls.

18. The method of claim 17 further comprising determining a delivery ETA based on the one or more manufacturer parameter controls, the post-release quality hold information, upfitter throughput information and historical delivery segment performance information.

19. An integrated computer-implemented system for determining a delivery estimated time of arrival (“ETA”) for a vehicle, the system comprised of one or more server computers and one or more client computers, the one or more client computers configured to:
receive post-release quality hold information, upfitter throughput information and historical delivery segment performance information relating to an undelivered vehicle; and
determine a delivery ETA for the undelivered vehicle based on the post-release quality hold information, upfitter throughput information and historical delivery segment performance information.

20. An integrated computer-implemented apparatus for determining a delivery estimated time of arrival (“ETA”) for a vehicle, the apparatus comprised of:
means for receiving post-release quality hold information, upfitter throughput information and historical delivery segment performance information relating to an undelivered vehicle; and
means for determining a delivery ETA for the undelivered vehicle based on the post-release quality hold information, upfitter throughput information and historical delivery segment performance information.
